(19) United States
(12) Patent Application Publication
(10) Pub. No.: US 2010/0318774 A1
(43) Pub. Date: Dec. 16, 2010

(54) PROCESSOR INSTRUCTION GRADUATION TIMEOUT

(75) Inventors: Dennis C. Abts, Eleva, WI (US); Aaron F. Godfrey, Eagan, MN (US)

Correspondence Address: SCHWEGMAN, LUNDBERG & WOESSNER, P.A., P.O. BOX 2938, MINNEAPOLIS, MN, 55402, US

(73) Assignee: Cray Inc., Seattle, WA (US)

(21) Appl. No.: 12/483,902

(22) Filed: Jun. 12, 2009

(51) Int. Cl. G06F 9/38; G06F 11/07

(52) U.S. Cl. 712/234; 714/23; 714/E11.023; 712/E09.062; 712/E09.045

(57) ABSTRACT

A multiprocessor computer system comprises a plurality of processors distributed across a plurality of node coupled by a processor interconnect network. One or more of the processors is operable to manage hung processor instructions by setting a graduation timeout counter after a first program instruction graduates, resetting the graduation timeout counter if a subsequent program instruction graduates before the graduation timeout counter expires, and resetting the processor if the graduation timeout counter expires before the subsequent program instruction graduates.

### FIELD OF THE INVENTION

The invention relates generally to computer processors, and more specifically to processor instruction graduation timeouts.

### BACKGROUND

Most general purpose computer systems are built around a general-purpose processor, which is typically an integrated circuit operable to perform a wide variety of operations useful for executing a wide variety of software. The processor is able to perform a fixed set of instructions, which collectively are known as the instruction set for the processor. A typical instruction set includes a variety of types of instructions, including arithmetic, logic, and data instructions.

Arithmetic instructions include common math functions such as add and multiply. Logic instructions include logical operators such as AND, NOT, and invert, and are used to perform logical operations on data. Data instructions include instructions such as load, store, and move, which are used to handle data within the processor.

Data instructions can be used to load data into registers from memory, to move data from registers back to memory, and to perform other data management functions. Data loaded into the processor from memory is stored in registers, which are small pieces of memory typically capable of holding only a single word of data.

Arithmetic and logical instructions operate on the data stored in the registers, such as adding the data in one register to the data in another register, and storing the result in one of the two registers.

Software programs are sets of instructions designed to cause the processor to perform certain tasks, such as performing calculations or manipulating data. The software instructions execute in sequence on one or more processors, manipulating data stored in the memory and in registers. When multiple processors are used, data used by the processors is often communicated between processors or nodes in the computer system using a processor interconnect network. The interconnect network enables processors to share information, facilitating faster execution of some programs.

But, the added complexity of multiprocessor systems can result in corrupt or missing data if the interconnect network, memory, or other components in the system fail. It is therefore desirable to manage various errors such as this in executing program instructions in computer systems.

### SUMMARY

One example embodiment of the invention comprises a multiprocessor computer system having a plurality of processors distributed across a plurality of node coupled by a processor interconnect network. One or more of the processors is operable to manage hung processor instructions by setting a graduation timeout counter after a first program instruction graduates, resetting the graduation timeout counter if a subsequent program instruction graduates before the graduation timeout counter expires, and resetting the processor if the graduation timeout counter expires before the subsequent program instruction graduates.

### BRIEF DESCRIPTION OF THE FIGURES

FIG. 1 shows a multiprocessor computer system having a processor interconnect network, consistent with an example embodiment of the invention.

FIG. 2 is a flowchart of an example method of managing hung processor instructions using a graduation timeout counter, consistent with an example embodiment of the invention.

### DETAILED DESCRIPTION

In the following detailed description of example embodiments of the invention, reference is made to specific example embodiments of the invention by way of drawings and illustrations. These examples are described in sufficient detail to enable those skilled in the art to practice the invention, and serve to illustrate how the invention may be applied to various purposes or embodiments. Other embodiments of the invention exist and are within the scope of the invention, and logical, mechanical, electrical, and other changes may be made without departing from the subject or scope of the present invention. Features or limitations of various embodiments of the invention described herein, however essential to the example embodiments in which they are incorporated, do not limit other embodiments of the invention or the invention as a whole, and any reference to the invention, its elements, operation, and application do not limit the invention as a whole but serve only to define these example embodiments. The following detailed description does not, therefore, limit the scope of the invention, which is defined only by the appended claims.

Sophisticated computer systems often use more than one processor to perform a variety of tasks in parallel, such as to perform large or complex functions more quickly. Multiprocessor computer systems are commonly found in scientific computing applications, where complex operations on large sets of data benefit from the ability to perform more than one operation on one piece of data at the same time.

The actual operations or instructions are performed in various functional units within the processor. A floating point add function, for example, is typically built in to the processor hardware of a floating point arithmetic logic unit, or floating point ALU functional unit of the processor. Similarly, vector operations are typically embodied in a vector unit hardware element in the processor which includes the ability to execute instructions on a group of data elements or pairs of elements. The functional units typically also work with other processor components such as an address decoder and other support circuitry so that the data elements can be efficiently loaded into registers in the proper sequence and the results can be returned to the correct location in memory.

Fetching data in multiprocessor computer systems often requires retrieving data from other processor nodes, which are connected by a processor interconnect network. In one such example, each node has multiple processors and memory local to the node, but uses network connections to other nodes to enable the node to exchange data with other processors to perform large or complex tasks in parallel. Reliability of the network and other components is important to ensure that the data provided to the processor is accurate, and reaches the requesting processor.

One example embodiment of the invention seeks to remedy some situations where a processor is unable to complete execution of an instruction, such as when the requested data cannot be retrieved from a remote processor node. This is achieved by using graduation timeouts, which measure the time during which an instruction is executing in a processor. When the time for a given instruction reaches a certain point, it can reasonably be concluded that the instruction has stalled, and the processor is restarted.

The timer in one embodiment is an instruction graduation timer, which is set to a predetermined value whenever an instruction completes execution. The counter counts down as clock cycles progress and the next instruction executes, and when the counter reaches zero it can be concluded that the next instruction is not likely to complete execution. In an alternate embodiment, the counter counts up to a predetermined number, or functions in another similar way.

The timer value is determined in one embodiment to be a large number, such that any instruction supported by the processor can reasonably be expected to complete during the allotted time. In other embodiments, the timer value varies depending on factors such as the instruction, and whether the data being used is present in local or remote. For example, a divide instruction can take fifty clock cycles to complete execution, while a shift instruction may be completed in only a few clock cycles. Similarly, performing a shift operation on data present in a processor's local registers may complete in a few clock cycles, while performing the same operation on data that must be fetched from a remote processing node can take millions or billions of clock cycles for the data to arrive in the requesting processor.

The graduation timeout therefore is desirably set to a large enough value that expiration of the graduation timeout counter indicates that the processor has stopped making forward progress in executing program instructions. When a graduation timeout occurs, it can be reasonably presumed that an instruction has “hung” the processor, such as where required data cannot be retrieved over the processor interconnect network. On a timeout, the instructions that are in various stages of execution in the processor's instruction pipeline are all cleared or flushed, and the processor is restarted.

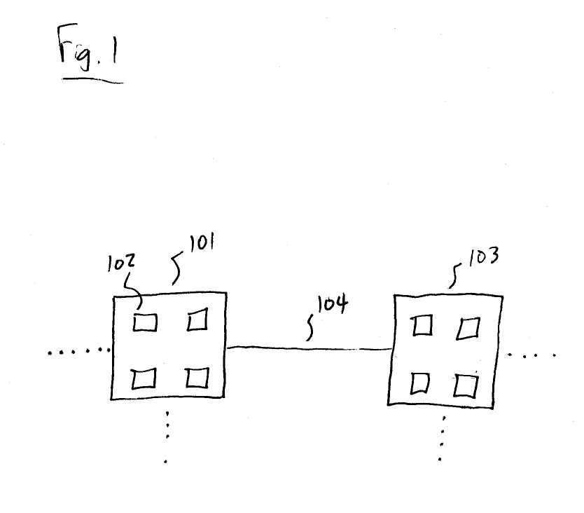

FIG. 1 shows an example multiprocessor computer system using processor graduation timeouts, consistent with an example embodiment of the invention. A first computer node 101 has a plurality of processors 102, each of which are operable to execute software instructions at the same time, such as to work together on large or complex tasks. The processor 102 may from time to time perform operations on data from remote nodes such as node 103, such that the data is conveyed over a processor interconnect network 104. On rare occasion, the data exchanged between processors becomes corrupted or is not sent, resulting in a pending instruction in the requesting processor 102 stalling or hanging.

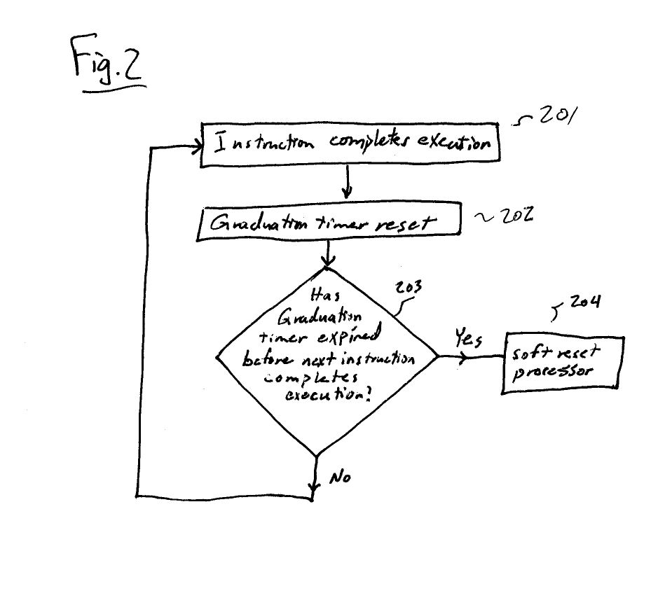

Problems such as this are addressed in some embodiments of the invention by a method such as the example shown in the flowchart of FIG. 2, which illustrates use of graduation timeouts to detect and recover from hung instructions. Here, when an instruction completes as shown at 201, a graduation timeout timer is reset at 202. The graduation timer is in a further embodiment set to a value specified in a graduation timeout register, while in other embodiments is reset to zero and is repeatedly compared to the value in a graduation timeout register.

If it is determined at 203 that a graduation timeout counter has reached the number of clock cycles in the graduation timeout register before the next instruction graduates, or completes execution, the pending instruction is deemed to be hung and an error condition is set. This results in a soft reset of the processor, as shown at 204. An error condition program counter, here referenced as ErrPC, records the program counter instruction point at which graduation failed. In a soft reset, the instructions in flight in the processor's pipeline are cleared, and the approximate program counter address of the hung instruction will be identified by an error program counter value. The processor then restarts execution in error mode at the error entry point.

In a further example, a fence instruction “Gsync_CPU” is used to periodically segment, or “fence” the series of program instructions. When an error such as a graduation timeout occurs, all the program instructions prior to the most recent Gsync_CPU instruction can be assumed to have executed properly. Instructions between the last Gsync_CPU and the next Gsync_CPU may have executed or may not have executed, including out-of-order execution of some instructions. More specifically, some instructions after the ErrPC might have graduated before the error condition was set, and some instructions following ErrPC might have executed before the error condition was set due to out-of-order execution.

The architectural state of the processor such as register and control settings prior to the most recent Gsync_CPU that are not altered before the next Gsync_CPU will remain intact as they are presumed to be correct as of the last Gsync_CPU. Other architectural state elements such as memory, vector registers, and some control registers will likely have been changed since the last Gsync_CPU, and cannot be corrected. Because it cannot be determined which instructions before the ErrPC-identified program instruction might not have executed or which instructions after the ErrPC-identified instruction might have executed, these state elements cannot be backed out or confirmed, and so must be presumed invalid.

Even though some data may be lost or corrupted, using graduation timeouts to reset a hung processor prevents the processor from hanging indefinitely, and enables resetting and recovery of the hung processor. Although specific embodiments have been illustrated and described herein, it will be appreciated by those of ordinary skill in the art that any arrangement that achieve the same purpose, structure, or function may be substituted for the specific embodiments shown. This application is intended to cover any adaptations or variations of the example embodiments of the invention described herein. It is intended that this invention be limited only by the claims, and the full scope of equivalents thereof.

What is claimed is:

1. A method of resetting a hung processor, comprising:
setting a graduation timeout counter after a first program instruction graduates;
resetting the graduation timeout counter if a subsequent program instruction graduates before the graduation timeout counter expires; and
resetting the processor if the graduation timeout counter expires before the subsequent program instruction graduates.

2. The method of resetting a hung processor of claim 1, wherein the graduation timeout counter is set using a timeout value specified in a register.

3. The method of resetting a hung processor of claim 2, wherein resetting the graduation timeout counter comprises resetting the graduation timeout counter to the timeout value specified in the register.

4. The method of resetting a hung processor of claim 1, wherein resetting the processor comprises clearing any remaining in-flight instructions from the processor's pipeline.

5. The method of resetting a hung processor of claim 1, further comprising approximately identifying the instruction that hung in the processor.

6. The method of resetting a hung processor of claim 5, wherein resetting the processor further comprises restarting execution in error mode at the instruction identified as approximately the instruction that hung the processor.

7. The method of resetting a hung processor of claim 1, wherein resetting the processor comprises leaving intact the architectural state of the processor not altered between a fence instruction graduated prior to the instruction that hung in the processor and the first fence instruction subsequent to the instruction that hung in the processor.

8. A computer processor comprising a graduation timeout error handler operable to:
set a graduation timeout counter after a first program instruction graduates;
reset the graduation timeout counter if a subsequent program instruction graduates before the graduation timeout counter expires; and
reset the processor if the graduation timeout counter expires before the subsequent program instruction graduates.

9. The computer processor of claim 8, wherein the graduation timeout counter is set using a timeout value specified in a register.

10. The computer processor of claim 9, wherein resetting the graduation timeout counter comprises resetting the graduation timeout counter to the timeout value specified in the register.

11. The computer processor of claim 8, wherein resetting the processor comprises clearing any remaining in-flight instructions from the processor's pipeline.

12. The computer processor of claim 8, the error handler further operable to approximately identify the instruction that hung in the processor.

13. The computer processor of claim 12, wherein resetting the processor further comprises restarting execution in error mode at the instruction identified as approximately the instruction that hung the processor.

14. The computer processor of claim 8, wherein resetting the processor comprises leaving intact the architectural state of the processor not altered between a fence instruction graduated prior to the instruction that hung in the processor and the first fence instruction subsequent to the instruction that hung in the processor.

15. A multiprocessor computer system, comprising a plurality of processors distributed across a plurality of node coupled by a processor interconnect network, one or more of the processors operable to:
set a graduation timeout counter after a first program instruction graduates;
reset the graduation timeout counter if a subsequent program instruction graduates before the graduation timeout counter expires; and
reset the processor if the graduation timeout counter expires before the subsequent program instruction graduates.

16. The multiprocessor computer system of claim 15, wherein a failed message in the processor interconnect network results in the graduation timeout counter expiring before requested data is received in the processor.

17. The multiprocessor computer system of claim 15, wherein resetting the processor comprises clearing any remaining in-flight instructions from the processor's pipeline.

18. The multiprocessor computer system of claim 15, the one or more of the processors further operable to approximately identify the instruction that hung in the processor.

19. The multiprocessor computer system of claim 18, wherein resetting the processor further comprises restarting execution in error mode at the instruction identified as approximately the instruction that hung the processor.

20. The multiprocessor computer system of claim 15, wherein resetting the processor comprises leaving intact the architectural state of the processor not altered between a fence instruction graduated prior to the instruction that hung in the processor and the first fence instruction subsequent to the instruction that hung in the processor.
